(19) United States
(12) Patent Application Publication
(10) Pub. No.: US 2019/0012532 A1
(43) Pub. Date: Jan. 10, 2019

(54) AUGMENTED REALITY DIGITAL CONSENT

(71) Applicant: Bank of America Corporation, Charlotte, NC (US)

(72) Inventors: Elizabeth S. Votaw, Potomac, MD (US); Stephen T. Shannon, Charlotte, NC (US)

(21) Appl. No.: 15/643,666

(22) Filed: Jul. 7, 2017

(51) Int. Cl. G06K 9/00; G06F 3/00; H04L 9/32

(52) U.S. Cl. CPC G06K 9/00355; G06K 9/00221; H04L 2209/72; H04L 9/3247; G06F 3/005

(57) ABSTRACT

A mobile device for securely authenticating user consent may be provided. The mobile device may include a settings management state. The mobile device may include a processor configured to: access the settings management state, create a personal profile for the user and process a plurality of settings created by the user. The settings may include description-type settings and live motion and/or behavior settings of the user. The mobile device may include a database for storing the plurality of settings and the user's personal profile. The storing may enable future authentication of the user. In response to the user attempting to consent to an initiator via the mobile device, the processor may be configured to perform a real-time profile validation check. The validation check may include capturing live motion and/or behavior of the user, verifying the live motion and/or behavior and instructing the initiator to accept the consent.

### FIELD OF TECHNOLOGY

This invention relates to receiving digital consent. Specifically, this invention relates to verifying the received consent using augmented reality and gesture recognition technology methods.

### BACKGROUND OF THE DISCLOSURE

Consent may be required in a variety of different environments. An entity may require an existing client and/or prospective client to receive, review and consent and/or otherwise agree to information and/or requirements included in specific documents. It may be difficult to verify that the consent was indeed provided by the correct individual.

In order to determine and/or verify the identity of the entity providing the consent, it may be desirable to use augmented reality and/or gesture recognition technology systems and methods.

### SUMMARY OF THE DISCLOSURE

A method for securely authenticating user consent is provided. The method may involve high-security communications.

The method may specifically involve mobile device communications. The method may utilize a mobile device. The method may authenticate the identity of a user by confirming the user's possession of the mobile device. The method may include accessing a settings management state. The settings management state may be associated with the mobile device. The method may include creating a personal profile for a user. The creation may be within the settings management state. The personal profile may be in connection with the mobile device. The settings may be stored on, and/or accessible by, the user of the mobile device.

The settings may include description-type settings related to the user. The settings may also include live motion and/or behavior settings of the user.

Live motion and/or behavior settings may include settings related to live motions and/or behaviors of the user. Such live motions may include steps per minute, eye movements, hand movements, pitch or tone of voice, speech speed, hand movements and any other suitable live motions and/or behaviors.

The method may include storing the initial settings of the user's personal profile for future authentication of the user. The live motion and/or behavior settings may include storing information relating to the steps per minute, eye movements, hand movements, pitch or tone of voice, speech speed, hand movements and any other suitable live motions and/or behaviors. The live motion and/or behavior settings may be determined by one or more of a voice recorder, a motion sensor, a mic, an input/output module, an audio/visual recorder and any other suitable associated hardware and/or software.

In response to the user attempting to consent, the method may include transmitting an invitation to the high-security communications sent by an initiator. The transmitting may be via the mobile device. The invitation may be sent to the mobile device in order to perform a real-time profile validation check of the user of the mobile device.

The real-time profile validation check may include capturing live motion and/or behavior of the user. The real-time profile validation check may include capturing a signature of the user. The real-time validation check may include verifying the live motion and/or behavior of the user by confirming that the real-time live motion and/or behavior corresponds to the initial personal profile settings stored on the mobile device. The capturing and verifying may be via the mobile device.

In some embodiments, the user may be unaware that the mobile device is capturing his or her live motions and/or behaviors. In these embodiments, the user may have granted permission to an application, resident on the mobile device, to allow for verification via live motions and/or behaviors at a different instance.

In other embodiments, the user may be aware and/or allow the mobile device to capture his or her live motions and/or behaviors. In these embodiments, the user may grant permission to an application, resident on the mobile device, to allow for verification via the live motion and/or behavior.

The method may include securely instructing the initiator to authenticate and securely accept the user's consent in response to verifying the motion and/or behavior of the user as corresponding to the signature inputted by the user.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIGS. 1A and 1B shows an illustrative diagram in accordance with principles of the invention;

FIG. 2 shows another illustrative diagram in accordance with principles of the invention; and

FIG. 3 shows yet another illustrative diagram in accordance with principles of the invention.

### DETAILED DESCRIPTION OF THE DISCLOSURE

Mobile communication devices are being increasingly used for high security communications. It would desirable to authenticate and verify the identity of a mobile communication device user in order to maintain the security of the communication. Such authentication and/or verification may avoid allegations of fraud or theft that may arise after completion of the communication.

A method to securely authenticate user consent is provided. User consent is preferably authenticated by verifying the identity of a user. Confirmation of the user's possession of the mobile device may verify the identity of the user.

The mobile device may include a settings management state. A user may create a personal profile within the settings management state. The personal profile may include configurable settings. Such personal profile settings may be stored on the mobile device. Such personal profile settings may also be accessible to the user of the mobile device.

The settings may include description-type settings relating to the user and/or live motion and/or behavior settings of the user. The settings may be stored on the mobile device for future authentication of the user.

Authentication may be performed via a real-time profile validation check of the user's mobile device. The real-time profile validation check may be initiated by transmitting an invitation to the mobile device. The invitation may prompt the user provide his or her consent.

Once prompted, the user may perform a live motion or other suitable behavior. Upon completion of the live motion or other suitable behavior, the mobile device may capture the live motion and/or behavior of the user. The live motion and/or behavior may be verified by confirming that such motion or behavior corresponds, above a predetermined level of correspondence, to the initial personal profile settings stored on the mobile device.

Once the live motion and/or behavior are verified, the mobile device may then safely instruct the initiator, of the invitation, to authenticate and securely accept the user's consent.

In some embodiments, the settings may include description type settings relating to the user's background, personality and/or physical appearance.

In some embodiments, the settings may include one or more live motion settings involving voice detection of the user, facial recognition of the user, body movements of the user, and/or physical dimensions of the user.

In some embodiments, the body movements may include body movements associated with a hand movement. In other embodiments, the body movements may include body movements associated with eye movements.

In some embodiments, the real-time profile validation check may be initiated by transmitting a short message service (“SMS”) message or email to the mobile device. The SMS message or email may be based on the stored personal profile settings.

With respect to the real-time profile validation check, such a check may be completed by transmitting a consent communication from the mobile device to the initiator.

The objects and advantages of the invention will be apparent upon consideration of the following detailed description, taken in conjunction with the accompanying drawings, in which like reference characters refer to like parts throughout, and in which:

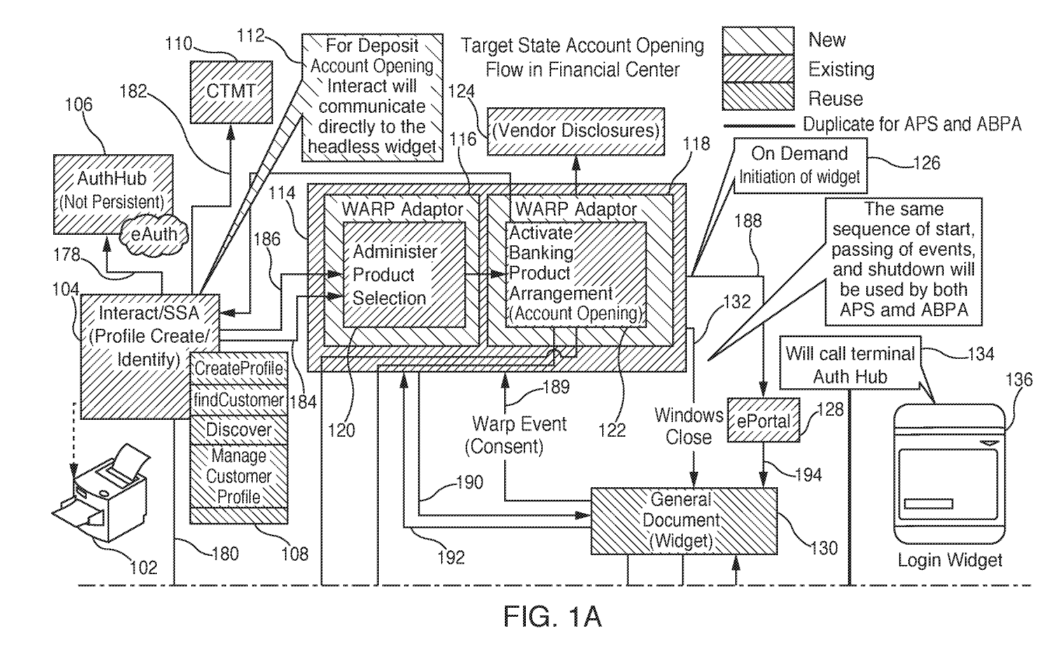

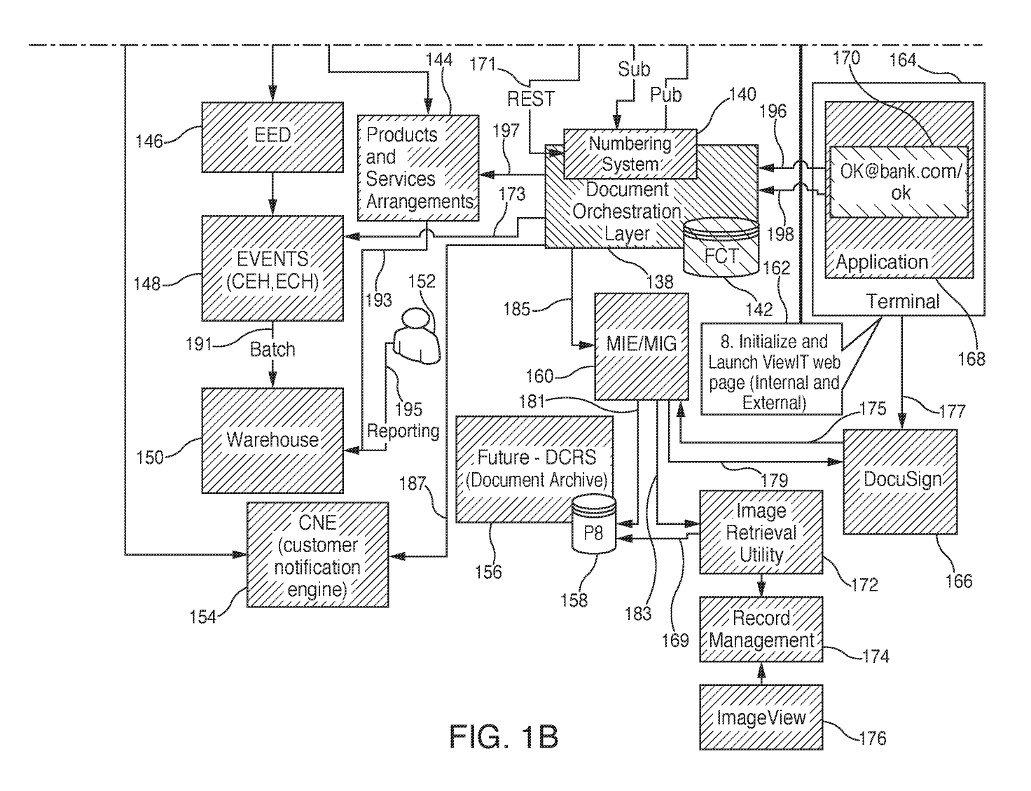

FIGS. 1A and 1B show a target state account opening flow in a financial center. A target state, for the purposes of this application, may be an ideal process flow.

At interaction 104, an interaction between an entity and a customer is initiated. Interaction 104 interaction may be initiated by the customer. Interaction 104 may be initiated by the entity. Interaction 104 may include completing a sales and service application (“SSA”). Interaction 104 may include creation of a profile for the customer. The profile may include information relating to the customer, such as name, address and phone number. The profile may include any accounts associated with the customer. The profile may also include biometric information relating to the customer. The biometric information may be used to authenticate a customer during the process flow. Interaction 104 may include identification of a profile for the customer. Interaction 104 may include executing one or more of operations 108.

Operations 108 may include methods steps which may be performed to initiate an interaction and/or subsequent to initiation of the interaction. Operations 108 may include tasks such as creating a profile, finding a customer, discover and manage a customer portal. During interaction 104, method steps may include communicating with physical hardware, such as printer 102.

Communication line 178 may link interaction 104 with authorization hub 106. Communication 178 may be conducted via Web Application Re-use Platform (“WARP”) events. Authentication hub 106 may authenticate the customer. Authentication hub 178 may operate in its own domain. Authentication hub 178 may provide an added layer of functionality by performing autonomously.

Using communication line 180, in the case of a digital authentication option, the customer associated with the login may be notified of the login attempt using customer notification engine (“CNE”) 154.

Communication line 182 links Module Channel Technology Mid-Tier (“CTMT”) 110 and interaction 104. CTMT 110 may generate one or more deposit forms. For example, CTMT 110 may generate a direct deposit form for a customer.

Communication line 184 links interaction 104 and administer product selection (“APS”) 120. Communication line 184 may transmit information generated during interaction 104 and thereby prime APS 120. Priming APS 120 may include utilizing data generated during interaction 104 to pre-populate APS 120. The data may include authentication data. The authentication data may have been received during interaction 104 from authentication hub 106 via communication line 178. In order to prime APS 120 a subroutine may be called and executed.

Communication line 186 may activate a banking product arrangement (“ABPA”) uniform resource locator (“URL”) at APBA 122. Interaction 104 may trigger launch of the ABPA URL in a separate window at ABPA 122.

Communication line 188 may initiate a headless generate document widget 130. The document widget may generate consent documents. Generate document widget 130 may be generated two or more times. For example, a first instance of widget 130 may be generated for APS 120. A second instance of widget 130 may be generated for ABPA 122. The document generation may be performed at a portal, such as electronic portal, shown at 128. Callout 126 shows that widget 130 may be generated on-demand. Callout 112 shows that, when interaction 104 includes a deposit account opening, interaction 104 may include transmitting information directly to widget 130.

A general document or consent document generated by widget 130, may be transmitted to the customer via communication link 194 or communication link 190. The document may be transmitted via one or more WARP events. Communication link 192 shows that ABPA 122 may be informed of which document is needed from the customer. ABPA 122 may communicate directly with vendor disclosures 124.

As shown at 162, the customer may initialize and launch a ViewIT web page. The ViewIT webpage may be an internal webpage with respect to the hosting entity. The ViewIT webpage may be an external webpage with respect to the hosting entity. In some embodiments, the initialized webpage may be webpage 170. Webpage 170 may be resident in application 168 at terminal 164. Terminal 164 may be a virtual terminal, such as a mobile device terminal. Terminal 164 may be a physical terminal, such as a banking center, automated teller machine (“ATM”) or automated teller assist (“ATA”).

Application 168 may poll document orchestration layer 138 for new documents, using communication 196. The documents may include account application documents, consent document, release documents and any other suitable documents. The documents may include information and/or requirements that may require consent and/or agreement from a customer. Document orchestration layer 138 may transmit, or display a document, which may be included in database 142, to the customer, using application 168. Application 168 may be running on a mobile device of the customer. The customer may transmit consent to document displayed within application 168 using communication line 198. The customer may also transmit the document from application 168 to document orchestration layer 138. Document orchestration layer 138 may store the consent and/or the document associated with the consent. The storage may be in database 142.

Document orchestration layer 138 may communicate with general document widget 130 via numbering system 140. Numbering system 140 may number each document. Numbering each document may enable tracking, recording and retrieval of each document.

Document orchestration layer 138 may update products and services arrangements (“PSA”) 144 available to the customer based on the consent and/or the document associated with the consent. PSA 144 may be accessed through application 168. The recordation of a consent and associated document may utilize representational state transfer (“REST”) services, as shown at 171. Documentation orchestration layer 138 may log customer event hub/enterprise customer event hub (“CEH/ECH”) 148 regarding the transmitted consent and/or consented document, as shown at 173. The information associated with CEH/ECH 148 may be transmitted to data warehouse 150 in batch files, as shown at 191. PSA 144 and entity 152 may also transmit reporting information to data warehouse 150, using communications 195 and 193, respectively.

CEH/ECH events 148 may receive vendor disclosure information from enterprise event data store (“EED”) 146.

General document widget 130 may transmit a WARP event, including the consent, to WARP communications collaboration center 114 via communication line 189. The warp event may be directed to the calling application, which may be APS 120 or ABPA 122 using WARP adaptors 116 or 118, respectively. Document orchestration layer 138 may transmit a notification to customer notification entity 154, via communication 187. The notification may notify the customer, via e-mail, text or other suitable communication mechanism, regarding the WARP event and its success or failure. Windows close communication 132 may show that the same sequence of start, passing of events, and shutdown may be used by both APS and ABPA.

Login Widget 136 may be associated with terminal 164. Login Widget 136 may securely call terminal 164, as shown at 134.

Document orchestration layer 138 may create an environment or get a URL using communication 185 with Message Integration Engine/Mortgage Integration Gateway (MIE/MIG) 160. MIE/MIG 160 may direct Image retrieval utility 172 (which may be used for bulk check statement image retrieval utility supporting various delivery channels and products) to generate a consent document via communication 183. MIE/MIG 160 may transmit metadata to database 158, included in document archive 156, via metadata feed 181. MIE/MIG 160 may transmit metadata to docusign 166 via metadata feed 179. The customer may electronically sign the consent document at terminal 164. The electronic consent may be transmitted to docusign 166 via communication 177. DocuSign 166 may transmit the consent to MIE/MIG 160 via communication 175. Communication 175 may determine the completion of the consent document signing event. Image retrieval utility 172 may also transmit the completion of the consent to database 158, via communication 169.

Image retrieval utility 172 and image view 176 may transmit the consent document to record management 174.

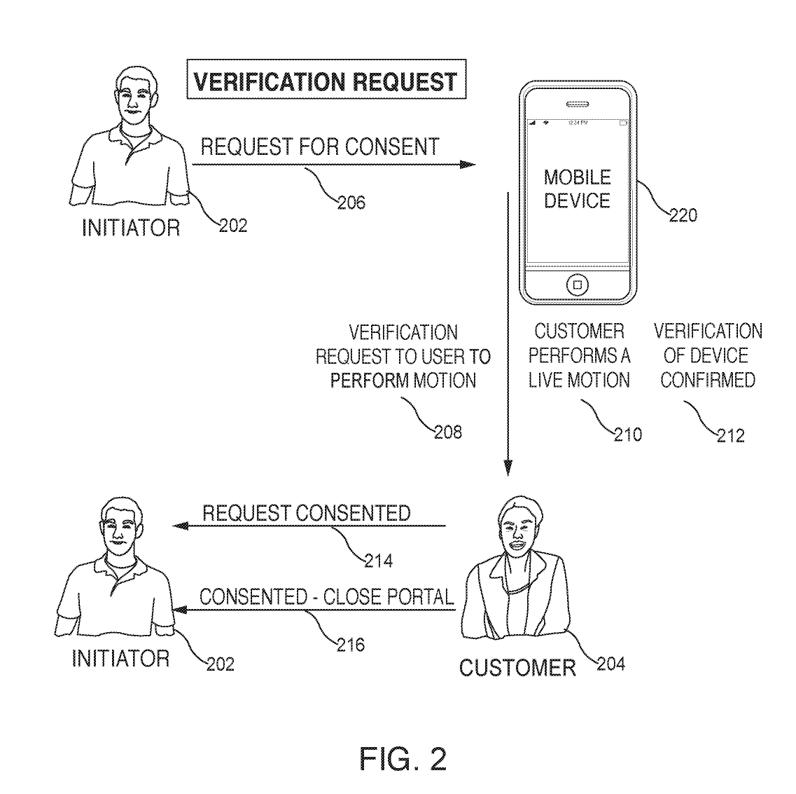

FIG. 2 shows an illustrative verification request flow 200. Flow 200 includes participants such as the initiator (202), the customer (204) and a mobile device (220). Mobile device 220 may have personal settings stored on it, such as description type settings, live motion settings and/or behavior settings.

At step 206, the initiator may transmit a request for consent to mobile device 220 belonging to customer 204.

At step 208, mobile device 220 may request customer 204 to perform a live motion or other behavior.

At step 210, customer 204 may perform a live motion or other behavior that is captured by mobile device 220.

At step 212, mobile device 220 may verify that the captured real time live motion and/or behavior corresponds to the initial personal profile settings stored on mobile device 220.

At step 214, mobile device 220 may safely instruct initiator 202 to authenticate and securely accept the consent of customer 204.

At step 216, the consent may be confirmed and the transmission portal may be closed.

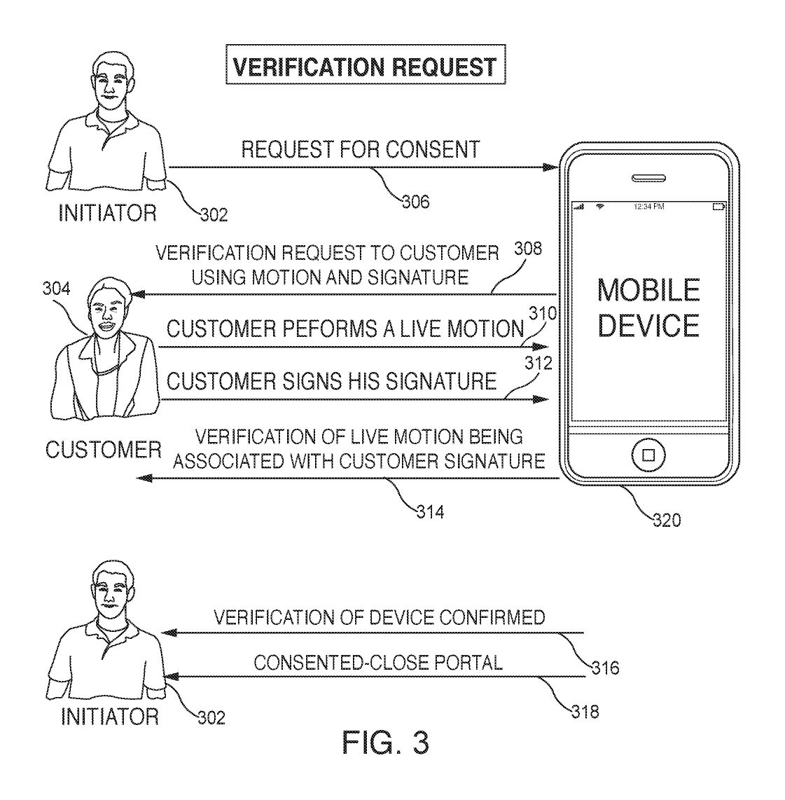

FIG. 3 shows illustrative verification request flow 300. Flow 300 includes participants such as the initiator (302), the customer (304) and a mobile device (320). Mobile device 320 may have personal settings stored on it such as description type settings or live motion or behavior settings.

At step 306, initiator 302 may transmit a request for consent to mobile device 320 belonging to customer 304.

At step 308, mobile device 320 may request customer 304 to perform a live motion and/or other behavior and provide a signature.

At step 310, customer 304 may perform a live motion and/or other behavior that is captured by mobile device 320.

At step 312, customer 304 may sign his signature.

At step 314, mobile device 320 may verify that the real time live motion and/or behavior captured, and the signature corresponds to the initial personal profile settings stored on mobile device 320.

At step 316, mobile device 320 may safely instruct initiator 302 to authenticate and securely accept the consent of customer 304.

At step 318, the consent is confirmed and the transmission portal is closed.

Thus, methods and apparatus for using augmented reality to provide real-time electronic consent methods and mechanisms, have been provided. Persons skilled in the art will appreciate that the present invention can be practiced by other than the described embodiments, which are presented for purposes of illustration rather than of limitation. The present invention is limited only by the claims that follow.

1. A method for securely authenticating user consent to a high-security communication via mobile communications, said method utilizing:
a mobile device, said method authenticating the identity of a user by confirming the user's possession of the mobile device;
said method comprising:
accessing a settings management state associated with the mobile device;
creating within the state, a personal profile for the user in connection with the mobile device, said settings being stored on, and accessible by, the user of the mobile device, said settings comprising:
description-type settings relating to said user; and
live motion settings and behavior settings of said user, the live motion settings comprising steps per minute of said user;
storing said initial settings of said user's personal profile for future authentication of the user; and
transmitting, in response to the user attempting to consent, via said mobile device, an invitation to the high-security communications sent by an initiator, said invitation being sent to said mobile device in order to perform a real-time profile validation check of the user of the mobile device, said real-time profile validation check comprising:
capturing, via said mobile device, live motion and behavior of the user;
verifying, via said mobile device, the live motion and behavior of the user, by confirming that the real-time live motion and behavior corresponds to the initial personal profile settings stored on the mobile device by the user of the mobile device;
in response to verifying the motion and behavior of the user, safely instructing the initiator to authenticate and securely accept the user's consent.

2. The method of claim 1 further comprising said description-type settings relating to said user's background, personality, and/or physical appearance.

3. The method of claim 1 further comprising said live motion settings involving voice detection of the user, facial recognition of the user, body movements of the user, and/or physical dimension of the user.

4. The method of claim 3 wherein said body movements are associated with a hand-movement.

5. The method of claim 1 further comprising, triggering said real-time profile validation check at the mobile device using text or an e-mail to the mobile device, said text or email being based on the stored user information.

6. The method of claim 5 further wherein said real-time profile validation check is completed by transmitting a consent communication from the mobile device to the initiator.

7. A method for securely authenticating user consent to a high-security communication via mobile communications, said method utilizing:
a mobile device, said method authenticating the identity of a user by confirming the user's possession of the mobile device;
said method comprising:
accessing a settings management state associated with the mobile device;
creating within the state, a personal profile for the user in connection with the mobile device, said settings being stored on, and accessible by, the user of the mobile device, said settings comprising:
description-type settings relating to said user; and
live motion settings and behavior settings of said user comprising steps per minute of said user;
storing said initial settings of said user's personal profile for future authentication of the user; and
transmitting, in response to the user attempting to consent, via said mobile device, an invitation to the high-security communications sent by an initiator, said invitation being sent to said mobile device in order to perform a real-time profile validation check of the user of the mobile device, said real-time profile validation check comprising:
capturing, via said mobile device, live motion and behavior of the user;
capturing, via said mobile device, a signature of the user;
verifying, via said mobile device, the live motion and/or behavior of the user, by confirming that the real-time live motion and behavior corresponds to the initial personal profile settings stored on the mobile device by the user of the mobile device;
verifying, via said mobile device, the signature of the user, by confirming that the signature corresponds to the initial signature stored on the mobile device by the user of the mobile device;
in response to verifying the motion and behavior of the user as corresponding to the signature inputted by the user, securely instructing the initiator to authenticate and securely accept the user's consent.

8. The method of claim 7 wherein said live motion settings involve voice detection of the user, facial recognition of the user, body movements of the user, and physical dimension of the user.

9. The method of claim 7 wherein said body movements is associated with a hand-wave.

10. The method of claim 7 wherein said signature of the user is an electronic hand-written signature.

11. A mobile device for securely authenticating user consent via mobile communications, said mobile device authenticating the identity of a user, said mobile device comprising:
a settings management state associated with the mobile device;
a processor for:
accessing the settings management state associated with the mobile device;
creating, within the state, a personal profile for the user in connection with the mobile device; and
processing a plurality of initial settings created by the user within his personal profile, said settings being stored on, and accessible by, the user of the mobile device, said settings comprising:
description-type settings relating to the user; and
live motion settings and behavior settings of said user comprising steps per minute of said user;
a database for storing the plurality of initial settings and the user's personal profile for future authentication of the user;
wherein, in response to the user attempting to consent to an initiator via the mobile device, the processor is further configured to:
receive a request from the initiator to the mobile device to perform a real-time profile validation check of the user using the mobile device based on the saved profile settings in the database of the mobile device;
perform said real-time profile validation check, said validation check comprising:
capturing, via the mobile device, live motion and behavior of the user;
verifying, via said mobile device, the live motion and behavior of the user, by confirming that the real-time live motion and behavior corresponds to the initial personal profile settings stored in the database on the mobile device, by the user;
wherein, in response to verifying the motion and behavior of the user, securely instructing the initiator to authenticate and securely accept the user's consent.

12. The mobile device of claim 11 wherein said description-type settings relate to said user's background, personality, and/or physical appearance.

13. The mobile device of claim 11 wherein said live motion settings involve voice detection of the user, facial recognition of the user, body movements of the user, and/or physical dimension of the user.

14. The mobile device of claim 13 wherein said body movements is associated with a hand-wave.

15. The mobile device of claim 11 wherein said real-time profile validation check further comprises the processor to receive at the mobile device a text or an e-mail, said text or email being based on the stored user information.

16. The mobile device of claim 11 wherein said real-time profile validation check is completed by transmitting a consent communication from the mobile device to the initiator.

17. (canceled)

18. The mobile device of claim 11 wherein said live motion settings involve pitch and/or tone of voice of the user.

19. The mobile device of claim 11 wherein said live motion settings involve eye movements of the user.

20. The mobile device of claim 11 wherein said live motion settings involve hand movements of the user.
